(19) United States
(12) Patent Application Publication
(10) Pub. No.: US 2023/0237440 A1
(43) Pub. Date: Jul. 27, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Masahiro YASUI, Kanagawa (JP)

(73) Assignee: FUJIFILM Business Innovation Corp., Tokyo (JP)

(21) Appl. No.: 17/884,265

(22) Filed: Aug. 9, 2022

(30) Foreign Application Priority Data
Jan. 21, 2022 (JP) 2022-007720

(51) Int. Cl. G06Q 10/10

(52) U.S. Cl. CPC G06Q 10/1095

(57) ABSTRACT

An information processing apparatus includes a processor configured to: receive an instruction to produce a meeting notice; acquire a schedule of a participant of a meeting, the schedule arranged within a meeting time of the meeting; if the participant is occupied during the meeting time, acquire log information on a conversation that the participant has made using a messenger application; and by analyzing the log information on the conversation, display information indicating whether holding of the meeting is possible during the meeting time.

### CROSS-REFERENCE TO RELATED APPLICATIONS

This application is based on and claims priority under 35 USC 119 from Japanese Patent Application No. 2022-007720 filed Jan. 21, 2022.

### BACKGROUND

### (i) Technical Field

The present disclosure relates to an information processing apparatus, a non-transitory computer readable medium, and an information processing method.

### (ii) Related Art

Schedules of employees of a company may be managed using a schedule management application, such as Outlook (registered trademark). If a meeting is arranged using the schedule management application, a user arranging a meeting may check schedules of participants set in the schedule management application and then arranges the meeting on free date and time, namely on date and time on which no schedule is assigned to all the participants.

In related art techniques, when a holding condition of a meeting is set by a meeting organizer, the meeting organizer inquires a schedule management agent of invitees of free schedules of the invitees falling in a range of set data and time and determines an optimum meeting schedule in accordance with the free schedule of each meeting invitee. For example, reference is made on Japanese Unexamined Patent Application Publication No. 09-91341.

In order to newly arrange a meeting, a user arranging the schedule of the meeting checks the schedule of each participant in the meeting, namely, free schedule of each participant and then arranges the schedule of the meeting. If a common free time period is available to all participants, the meeting may be held without any problem by arranging the meeting within that free time period. In such a case, information that it is possible to hold the meeting is provided.

When the schedules of the participants are referred to, free time may not necessarily be shared by all the participants during desired meeting time period. If no free time is found, information that it is difficult to hold the meeting is provided.

Recently, computer users have typically exchanged information by exchanging messages using a messenger application, namely, by exchanging conversation on a computer system. Similarly, participants of a meeting converse using a messenger application. In such a case, message exchange may be performed about the schedule of each participant.

### SUMMARY

Aspects of non-limiting embodiments of the present disclosure relate to providing information that indicates whether or not to hold a meeting and that is obtained as a result of referring to a log of conversation that participants of the meeting have performed using a messenger application.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: receive an instruction to produce a meeting notice; acquire a schedule of a participant of a meeting, the schedule arranged within a meeting time of the meeting; if the participant is occupied during the meeting time, acquire log information on a conversation that the participant has made using a messenger application; and by analyzing the log information on the conversation, display information indicating whether holding of the meeting is possible during the meeting time.

### BRIEF DESCRIPTION OF THE DRAWINGS

Exemplary embodiments of the present disclosure will be described in detail based on the following figures, wherein:

FIG. 1 is a block diagram illustrating a schedule management system and schedule management apparatus in a first exemplary embodiment;

FIG. 2 is a flowchart illustrating a meeting setting process of the first exemplary embodiment;

FIG. 3 illustrates an example of a schedule setting screen in the first exemplary embodiment;

FIG. 4 illustrates a setting example of schedules of participants in the first exemplary embodiment;

FIG. 5 illustrates part of conversation log information acquired from a chat system in the first exemplary embodiment;

FIG. 6 illustrates schedules that result from adjusting the schedules of the participants illustrated in FIG. 4;

FIG. 7 illustrates a setting example of schedules of participants in a second exemplary embodiment;

FIG. 8 illustrates part of the conversation log information acquired from the chat system in the second exemplary embodiment;

FIG. 9 illustrates schedules that are obtained by adjusting the schedules of the participants illustrated in FIG. 7;

FIG. 10 illustrates a setting example of schedules of participants in a third exemplary embodiment;

FIG. 11 illustrates part of the conversation log information acquired from the chat system in the third exemplary embodiment;

FIG. 12 illustrates schedules that are obtained by adjusting the schedule of the participants illustrated in FIG. 10;

FIG. 13 illustrates a setting example of schedules of the participants in a fourth exemplary embodiment;

FIG. 14 illustrates part of the conversation log information acquired from the chat system in the fourth exemplary embodiment;

FIG. 15 illustrates schedules that are obtained by adjusting the schedule of the participants illustrated in FIG. 13;

FIG. 16 illustrates a setting example of schedules of the participants in a fifth exemplary embodiment;

FIG. 17 illustrates part of the conversation log information acquired from the chat system in the fifth exemplary embodiment;

FIG. 18 illustrates schedules that are obtained by adjusting the schedule of the participants illustrated in FIG. 16;

FIG. 19 is a flowchart illustrating a meeting setting process of a sixth exemplary embodiment;

FIG. 20 illustrates a setting example of schedules of the participants in a sixth exemplary embodiment;

FIG. 21 illustrates part of the conversation log information acquired from the chat system in the sixth exemplary embodiment; and

FIG. 22 illustrates schedules that are obtained by incorporating schedules, obtained through analysis of the conversation log information, into the schedules of the participants in FIG. 20.

### DETAILED DESCRIPTION

Exemplary embodiments of the disclosure are described with reference to the drawings.

### First Exemplary Embodiment

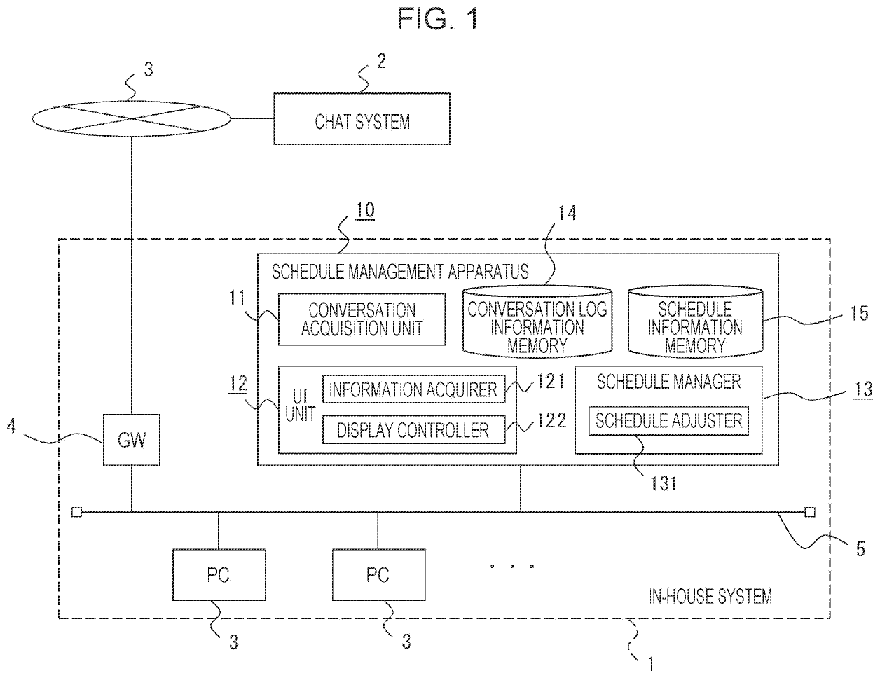

FIG. 1 is a block diagram illustrating a schedule management system and schedule management apparatus of a first exemplary embodiment. In the system structure in FIG. 1, an in-house system 1 of a company is connected to a chat system 2 via a network 3, such as the Internet.

Chat is defined as a mechanism that permits conversation to be performed on a real-time basis through the Internet. The chat system 2 provides a chat service to users that use computers on which chat applications are installed. The chat system 2 of the first exemplary embodiment may be a general-purpose system.

The messenger application (hereinafter referred to as “app”) is a generic term of an application that provides a messaging function, namely, text message exchange or message exchange via free Internet protocol (IP) phone. According to the first exemplary embodiment, the messaging function is provided to users using a chat app as the messenger app. Other messenger apps providing the messaging function may also be employed.

The in-house system 1 is a local-area network (LAN) 5 constructed in the facility of a company. The in-house system 1 includes the schedule management apparatus 10, personal computers (PCs) 3, and gateway (GW) 4, all connected to the LAN 5. FIG. 1 illustrates elements described in connection with the disclosure and other elements are not illustrated. The schedule management apparatus 10 and the PCs 3 may communicate with the chat system 2 via the GW 4.

The PCs 3 are information processing apparatuses used by employees (hereinafter referred to as users) that uses the in-house system 1 in the company. The PC 3 may be implemented by an existing general-purpose hardware configuration. Specifically, the PC 3 includes a central processing unit (CPU), read-only memory (ROM), random-access memory (RAM), storage such as hard disk drive (HDD), network interface serving as a communication medium, and user interface including an input unit, such as a mouse and keyboard, and a display unit. The PC 3 has a chat app installed thereon and exchanges messages via the chat system 2 with a PC 3 used by another user and the schedule management apparatus 10. The PC 3 also has a schedule management app. Under the control of the schedule management apparatus 10, the user adjusts job schedule and manages personal schedules.

FIG. 1 illustrates only the PCs 3 installed in the company. For example, the user may similarly exchange messages via chat through a network 3 using a PC 3 at a place, such as at home, outside the company. The user may also access the schedule management apparatus 10 using the PC 3.

The schedule management apparatus 10 is an information processing apparatus that performs schedule management of the user. The schedule management apparatus 10 of the first exemplary embodiment may be implemented by a general-purpose existing hardware configuration, such as a server computer. The schedule management apparatus 10 includes at least a CPU, ROM, RAM, storage such as a hard disk drive (HDD), and a network interface serving as a communication medium. The schedule management apparatus 10 has a chat app installed thereon. The schedule management performed by the schedule management apparatus 10 may be implemented by a software product developed by the company itself. The schedule management may be provided by a product, such as Outlook (registered trademark) that performs job schedule adjustment or personal schedule management.

The schedule management apparatus 10 includes a conversation acquisition unit 11, user interface (UI) 12, schedule manager 13, conversation log information memory 14, and schedule information memory 15. Elements not described in connection with the first exemplary embodiment are not illustrated.

The conversation acquisition unit 11 acquires the conversation log information between users from the chat system 2. More precisely, the conversation acquisition unit 11 acquires a message posted on a web page (hereinafter referred to as a “chat room”) that the chat system 2 provides as an area of exchange of messages in a specific group. Exchange of messages posted herein is hereinafter referred to as a conversation. The conversation acquisition unit 11 accumulates acquired conversation log information on the conversation log information memory 14.

The user uses the UI unit 12 to exchange information on a screen thereof with the PC 3. The UI unit 12 includes an information acquirer 121 and display controller 122. The schedule arranged for each user is stored on the schedule information memory 15 and managed by the schedule manager 13. The information acquirer 121 receives an instruction to produce a meeting notice from an organizer of a meeting. The production instruction includes request-to-hold information related to a meeting that is upcoming but is not arranged yet. The request-to-hold information includes information items related to the upcoming meeting, including the name, participants, and date and time of the meeting, and the length of the meeting time of the meeting, and the venue and purpose of the meeting. According to the first exemplary embodiment, the request-to-hold information includes at least the names of the participants and the meeting time. The information acquirer 121 acquires information via a schedule setting screen displayed on the PC 3 and the display controller 122 performs display control on the PC 3, particularly display control on a schedule setting screen.

The schedule manager 13 manages the schedule of a user. The function of a schedule adjuster 131 in the schedule manager 13 may be implemented using a related-art schedule management app. The schedule adjuster 131 in the schedule manager 13 acquires from the PC 3 information on at least participants and meeting time specified by the organizer of the meeting, acquires schedules of the participants of the meeting, and adjusts a schedule of a participant if that participant has another plan during the meeting time. The schedule adjuster 131 determines whether the adjustment of the schedule permits the meeting to be held during the meeting time as requested, and provides information by causing the PC 3 of the organizer to display determination results on the display controller 122.

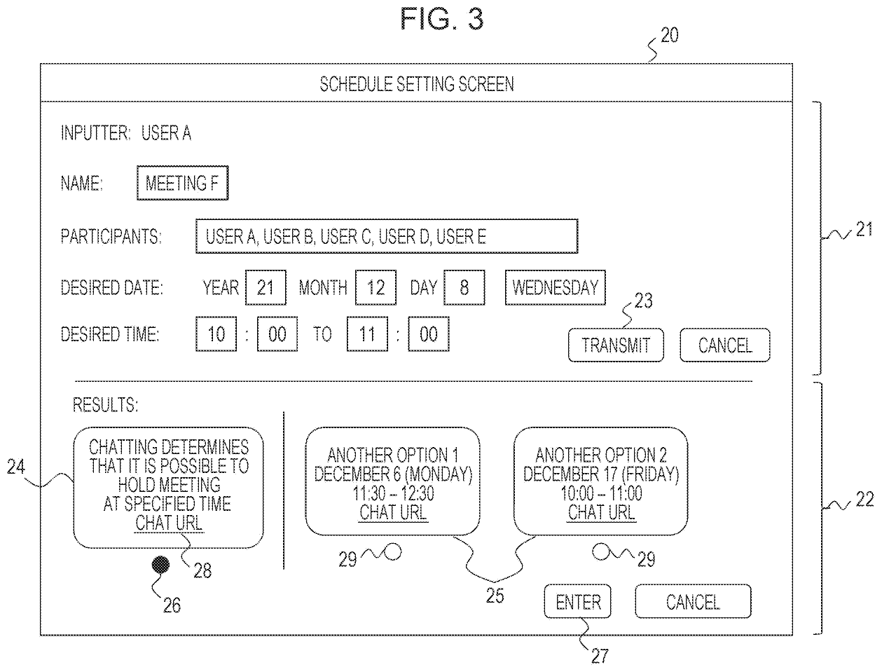

The term “meeting” refers to a specific gathering for a particular purpose and serves as a target of schedule arrangement. Referring to FIG. 3, the meeting time represents the date of the meeting, the start time of the meeting and the end time of the meeting. For example, the meeting time may be specified by a length of time and a time band, for example, “1 hour in the morning.” The meeting time is not specifically limited to any format. The schedule serving as an adjustment target may be a schedule arranged on the schedule management apparatus 10 or setting contents of request-to-hold information on the meeting serving as a schedule setting target (specifically, meeting holding conditions). According to the first exemplary embodiment, the schedule adjustment target may be the schedule set on the schedule management apparatus 10.

The conversation log information memory 14 stores, as the conversation log information, contents of conversations made among users via a chat app. The conversation log information includes information that may identify the date and time of a conversation (namely, the date and time of message posting) and a chat room where a message is posted, identification information on a user that has posted the message, and contents of the conversation (i.e., the contents of the posted message). According to the first exemplary embodiment, a message is posted in the form of text. Alternatively, a voice or the like may be used in place of text. In such a case, the contents of the conversation are recorded as voice data.

The schedule information memory 15 stores the schedule of each user. The schedule includes typical setting contents, such as the meeting time and the contents of the schedule.

Elements 11 through 13 in the schedule management apparatus 10 are implemented by a cooperative operation of a computer forming the schedule management apparatus 10 and a program running on a CPU mounted on the computer. Memories 14 and 15 are implemented by HDDs mounted on the schedule management apparatus 10. Alternatively, the memories 14 and 15 may be RAMS or external memories connected via a network.

A program used in the first exemplary embodiment may be provided via a communication medium or may be provided via a computer-readable recording medium, such as compact disc read-only memory (CD-ROM) or universal serial bus (USB) memory, having recorded the program. The program provided via the communication medium or the recording medium is installed on the computer and processes are implemented when the CPU on the computer executes the program.

The schedule management apparatus 10 of the first exemplary embodiment utilizes an external chat system 2. Alternatively, a chat system developed in-house may be included in the in-house system 1. In such a configuration, a data structure of the conversation log information may be customized and the conversation log information may be more easily acquired. On the other hand, the schedule management apparatus 10 of the first exemplary embodiment may be configured to utilize an external management function over cloud.

Processes of the first exemplary embodiment are described below.

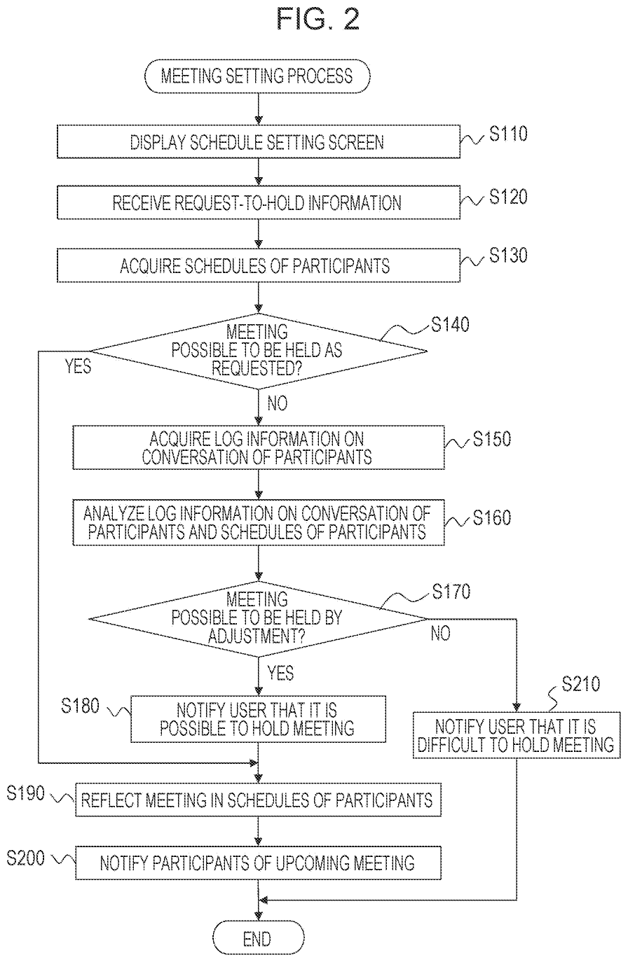

According to the first exemplary embodiment, the set schedule of each participant may be referenced. Even when it is difficult to arrange, as requested, a meeting serving as a schedule setting target, analyzing of log information on a chat-based conversation may determine that the schedule arranged for participants is adjustable. In such a case, the meeting may be held as requested by adjusting the set schedule. Whether the holding of the meeting is actually possible or not may be determined based on the venue of the meeting, availability of meeting rooms, or travel time of each participant. The discussion that follows is based on the assumption that all conditions for holding the meeting are satisfied except for the participants and meeting time. Project F is a group to which multiple users belong. When a meeting is to be held by all or some of the users belonging to the project F, a user A belonging to the project F instructs the schedule management apparatus 10 to produce a meeting notice for the participants. A meeting setting process in which a meeting schedule is newly set on the schedule management apparatus 10 is described below with reference to FIG. 2.

The user A may now wish to newly arrange the schedule of a meeting. The user A logs in on the PC 3, starts up a schedule management app, and performs a predetermined screen display operation. In response to the user operation, the display controller 122 in the schedule management apparatus 10 causes the PC 3 of the user A to display a page of a predetermined schedule setting screen (step S110).

FIG. 3 illustrates an example of a schedule setting screen 20. The schedule setting screen 20 includes an input region 21 and result display region 22. The input region 21 receives information used to set the meeting schedule of the meeting. The result display region 22 displays information as to whether the holding of the meeting is possible, namely, results of a process performed by the schedule management apparatus 10 in response to the setting contents onto the input region 21.

The user A may now wish to arrange a meeting for the project F the user A belongs to (in the first exemplary embodiment, the meeting is referred to as “meeting F”). The user A enters data for items in the input region 21 on the schedule setting screen 20, specifically, a name displayed when the schedule is arranged (“meeting F”), participants, desired date and time for the meeting, start time and end time of the desired date, and then provides an instruction to produce the meeting notice by selecting a transmit button 23. In response to when the user A selects the transmit button 23, the schedule management app installed on the PC 3 transmits to the schedule management apparatus 10 the request-to-hold information including the specified name, participants, and desired time information. By specifying the start time and end time, the user A has specified the length of the meeting time of the meeting.

When the PC 3 of the user A transmits the production instruction for the meeting notice and the request-to-hold information, the information acquirer 121 in the schedule management apparatus 10 receives the request-to-hold information (step S120).

By referencing the schedule information memory 15, the schedule manager 13 acquires the meeting time set for the meeting F, namely, the schedule of a participant of the meeting F included in the request-to-hold information (step S130). The schedule manager 13 references the acquired schedules of the participants, namely, users A through E in the setting example in FIG. 3 and determines whether setting the schedule of the meeting within the specified meeting time is possible. That the setting of the schedule of the meeting is possible signifies that the schedule of the meeting is set and registered on the schedule information memory 15 and thus signifies that the holding of the meeting is possible. The persons serving as the schedule target acquisition are basically all the participants included in the request-to-hold information. However, depending on the number of participants to the meeting and subject of the meeting (specifically, the contents of the meeting, such as the meeting including a debriefing session only or the meeting involving matters to be decided), users may be divided into users who are required to participate and users who do not necessarily have to participate. If the levels of the participants are determinable, the schedules of participants at a specific level (in this case, users who are required to participate) may be selectively acquired.

If none of the participants are occupied during the meeting time, the holding of the meeting is possible as requested (yes path in S140). The schedule manager 13 reflects the meeting F in the schedules of the participants by setting and registering the meeting schedule of the meeting on the schedule information memory 15 (step S190). The schedule manager 13 informs an inputter and participants of the holding of the meeting F by notifying the inputter and participants of the setting of the schedule of the meeting F (step S200).

If one of the participants is occupied in the meeting time, it is difficult to set the schedule of the meeting F to be within the specified meeting time. Specifically, the holding of the meeting during the meeting time is difficult. If referencing schedule information determines that the holding of the meeting during the meeting time is difficult (no path in S140), the schedule management apparatus 10 performs a process characteristic of the first exemplary embodiment.

The conversation acquisition unit 11 acquires from the chat system 2 the log information on a conversation of participants (step S150) and stores the conversation log information on the conversation log information memory 14. Although the time range of the acquisition is not limited to any range but may be a time range available extending from the immediately preceding conversation back to a previous time point. The acquisition target is a conversation between participants and in the first exemplary embodiment, and the acquisition target is a log of conversation made between project members of the project F using a chat room. Alternatively, for example, the log of conversation that an individual participant has made with a user other than the project members may be acquired. For convenience of explanation, the acquisition target may be a log of conversation made between the project members of the project F using the chat room.

The schedule adjuster 131 determines whether the holding of the meeting during the meeting time is possible, by analyzing the schedule information on the participants set on the schedule information memory 15 and the conversation log information stored on the conversation log information memory 14 (step S160).

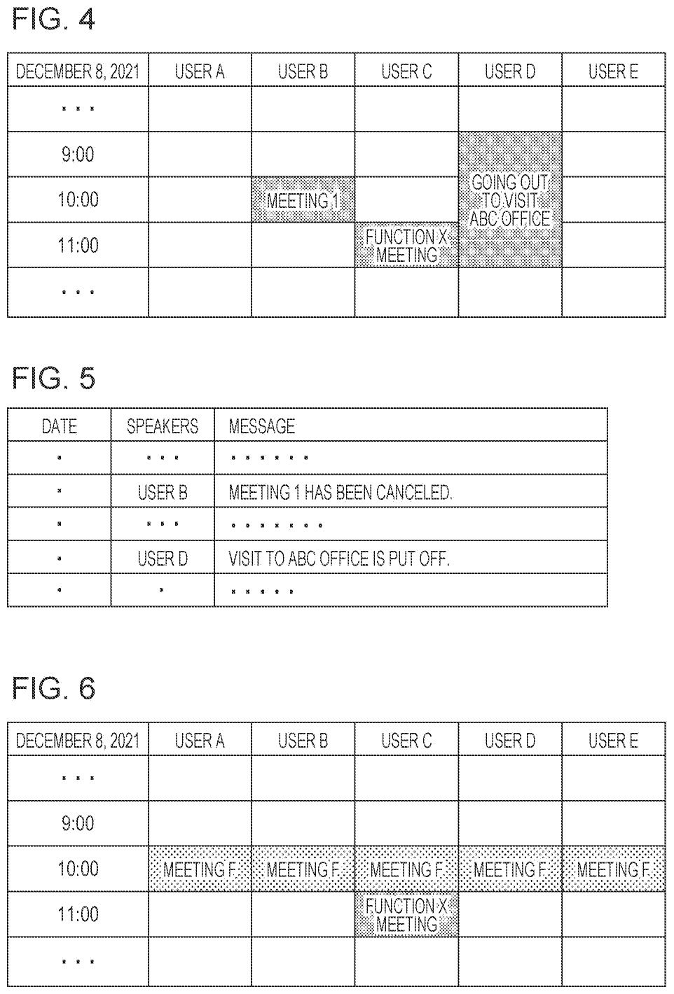

FIG. 4 illustrates a setting example of the schedule information on the participants within a time period including the meeting time. Referring to FIG. 4, users B and D have schedules during desired meeting time (10:00-11:00) on desired date (Dec. 8, 2021).

FIG. 5 illustrates part of the conversation log information acquired from the chat system 2. The schedule adjuster 131 interprets the contents of conversation through natural language processing. Analyzing of the conversation log information in FIG. 5 determines that the schedule of meeting 1 expected to start from 10:00 and expected to be attended by the user B is canceled. The analyzing of the conversation log information in FIG. 5 also determines that the schedule of the user D to go out from 9:00 is put off. Although the schedules of the users B and D during the meeting time are modified, the schedule adjuster 131 determines that the modified schedules are not reflected in the schedule information that the schedule manager 13 manages using the schedule information memory 15. The schedule adjuster 131 determines that the meeting F may be arranged during the meeting time as requested by deleting the schedules of the users B and D that are not to be executed as scheduled but still remain set.

As described above, in response to an instruction to produce the meeting notice from the user A, the schedule management apparatus 10 determines whether the holding of the meeting F during the desired meeting time is possible. In this example, the schedule management apparatus 10 determines that the schedules of the users B and D set on the schedule information memory 15 are adjustable, and thus determines that the holding of the meeting F is made possible by adjusting the schedules. In this case (yes path in S170), the display controller 122 notifies the user A that the holding of the meeting F is possible by displaying, on the result display region 22 of the schedule setting screen 20, determination results, namely, information 24 indicating that the holding of the meeting F is possible (step S180). In the first exemplary embodiment, the adjustment of a schedule signifies deletion of the schedule.

If the holding of the meeting is still difficult even with the schedules of the participants adjusted (no path in S170), the display controller 122 notifies the user A of the information indicating that the holding of the meeting is difficult, by causing the result display region 22 of the result display region 22 in the schedule management apparatus 10 to display the information indicating that the holding of the meeting is difficult (step S210). Information 25 related to alternative meeting time will be described below.

If the schedule management apparatus 10 determines that the holding of the meeting is possible during the meeting time as requested, the user A may wish to confirm the schedule of the meeting F. The user A may select an enter button 27 after selecting a radio button 26 displayed responsive to the information 24 indicating that the holding of the meeting is possible.

According to the first exemplary embodiment, the referencing of the schedule information determines that not all the participants are originally free during the meeting time but the analyzing of the conversation log information determines that the participants are actually free during the meeting time. The user A visually recognizes a message “Chatting determines . . . ” included in the information 24 indicating that the holding of the meeting is possible and hyperlink “chat URL.” As long as the schedule information is concerned, the holding of the meeting is difficult. Although the referencing of the schedule information determines that the holding of the meeting is difficult, the analyzing the conversation log information determines that the holding of the meeting during the meeting time is made possible. By referencing the conversation log information, the user A thus learns that the schedule adjustment has made the holding of the meeting possible. The user A may wish to know a basis on which to adjust the schedule. According to the first exemplary embodiment, the user A is presented with the log of the conversation that includes at least the contents of the conversation serving as a basis on which to adjust the schedule.

If the user A selects the hyperlink “Chat URL” 28 included in the information 24, the schedule manager 13 extracts from the conversation log information memory 14 the log of a conversation that serves as a basis on which to perform the schedule adjustment. The display controller 122 displays the log of the conversation on the screen thereof. Specifically, the conversation log information in FIG. 5 is displayed to the user A. The display format to display the conversation log information may be the format in FIG. 5 or a chat room format.

In the first exemplary embodiment, the hyperlink 28 is displayed on the screen such that the conversation log information serving as a basis on which to adjust the schedule is displayed in response to the selection operation of the user A. The disclosure is not limited to this manner. For example, if the analyzing of the conversation log information determines that the holding of the meeting during the meeting time is made possible, the conversation log information may be automatically displayed. For example, the display controller 122 may display side by side on the screen both a window for the schedule setting screen 20 and a window for the display screen of the conversation log information.

In response to the enter button 27 selected by the user A, the schedule manager 13 reflects the meeting F in the schedules of the participants during the meeting time identified by the information responsive to the radio button 26 selected (step S190). The schedule manager 13 sets and registers the schedule of the meeting F on the schedule information memory 15. The schedule manager 13 notifies the participants that the schedule of the meeting F is arranged (step S200). This notice may be made by a chatbot that posts a message in a chat room of the project F. Alternatively, the notice may be made by mailing each of the participants.

FIG. 6 illustrates the schedules of the participants that have resulted from adjusting the schedules of the participants in FIG. 4 through the process described above. Referring to FIG. 6, the schedules of the users B and D within the meeting time in FIG. 4 are deleted through the process described above and the schedule of the meeting F is incorporated within the meeting time. The schedules of users A through E as the participants in FIG. 6 thus result.

As described above, in the first exemplary embodiment, if the analyzing of the conversation log information determines that the schedules of the participants are adjustable within the meeting time, specifically, if the analyzing of the conversation log information determines that the schedules of the users B and D are deletable, the schedule management apparatus 10 determines that the holding of the meeting is possible within the meeting time and displays the information 24 indicating that the holding of the meeting is possible. By setting up the hyperlink 28, the conversation log information serving as a basis that determines that the schedules are adjustable is displayed. However, the schedule management apparatus 10 may check with the users B and D to confirm whether to actually delete the schedules.

By analyzing the schedule information and conversation log information, the schedule manager 13 determines whether the holding of the meeting is possible in a time period other than the meeting time. If alternative meeting time is found, the schedule manager 13 displays information 25 on the alternative meeting time together with the information 24 indicating that the holding of the meeting is possible. As described above, the conversation log information is acquired if it is difficult to hold the meeting F as requested (no path in step S140 and S150). Regardless of whether the holding of the meeting is possible as requested, the conversation log information may be acquired in order to provide the information 25 on the alternative meeting time or in order to use the conversation log information for another application purpose (for example, as described with reference to a sixth exemplary embodiment). The information 25 on the alternative meeting time may be provided as additional information.

If the alternative meeting time indicated by the information 25 is acceptable, the user A selects a corresponding button 29 to enable the meeting to be held within the alternative meeting time. If it is difficult to hold the meeting F in the desired meeting time (no path in step S170), the user A is notified as described above that the arrangement of the meeting is difficult (step S210). In this case, as well, the schedule manager 13 may cause the display controller 122 to display in the result display region 22 the information 25 on the alternative meeting time in FIG. 3 as information indicating that the arrangement of the meeting is difficult. In this way, if it is difficult to hold the meeting F in the meeting time, the user A is free from referencing the schedules of the participants and finding the alternative meeting time.

According to the first exemplary embodiment, if the schedule management apparatus 10 determines that the holding of the meeting F is possible within the meeting time, the user A is notified so and a decision as to whether to arrange the meeting F is left to the user A. The schedule of the meeting F may be automatically set and registered on the schedule information memory 15.

### Second Exemplary Embodiment

According to the first exemplary embodiment, the schedules of the participants are referenced. The holding of the meeting F during the meeting time as requested may be difficult and the analyzing of the conversation log information may determine that the schedules of the participants are adjustable. Specifically, if schedules that are not to be implemented remain set as the schedules of the users B and D, those schedules are deleted such that the holding of the meeting F during the meeting time is possible.

In a second exemplary embodiment, the referencing of the schedules of the participants may determine that the holding of the meeting F is difficult, and the analyzing of the conversation log information may determine that the schedules of the participants with respect to the meeting time are adjustable. If the modifiable schedules of the participants are found, the meeting time of the schedules may be modified such that the holding of the meeting is possible during the meeting time.

The system configuration (FIG. 1) and the meeting setting process (FIG. 2) of the second exemplary embodiment remain unchanged from those of the first exemplary embodiment.

The process of setting the meeting in the second exemplary embodiment is described below.

The second exemplary embodiment is identical to the first exemplary embodiment in the process (steps S110 through S130) that is performed by the user A and includes an operation to select the transmit button 23 on the schedule setting screen 20 to an operation to provide the instruction of the meeting notice. The second exemplary embodiment is identical to the first exemplary embodiment in the process performed when the referencing of the schedule information determines that the holding of the meeting is possible as requested (yes path in step S140). The discussion of these processes is not repeated herein. If the referencing of the schedule information determines that the holding of the meeting during the meeting time is difficult, the schedule adjuster 131 analyzes the schedules of the participants and conversation log information and determines whether the holding of the meeting is possible during the meeting time (no path in step S140 and steps S150 and S160). The second exemplary embodiment is identical to the first exemplary embodiment in this process as well and the discussion of the process is not repeated herein.

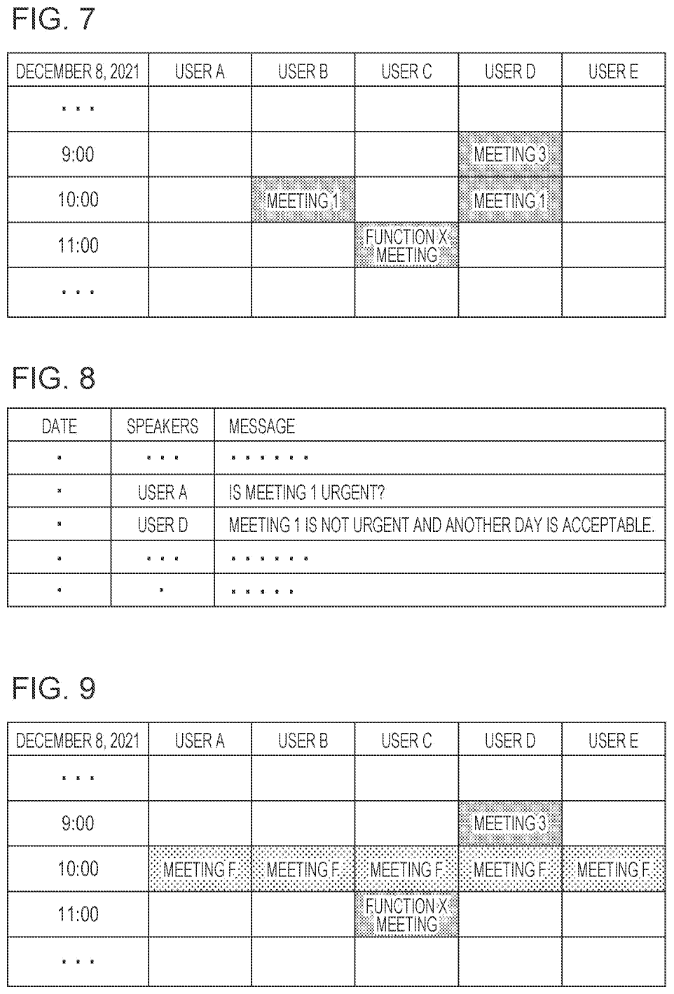

FIG. 7 illustrates a setting example of the schedule information on the participants, obtained in accordance with the second exemplary embodiment, in a time period including the meeting time, and corresponds to FIG. 4 in the first exemplary embodiment. FIG. 8 illustrates part of the log information on a conversation acquired from the chat system 2 in accordance with the second exemplary embodiment, and corresponds to FIG. 5 in the first exemplary embodiment.

The analyzing of the conversation log information in FIG. 8 determines that a meeting 1 of the users B and D that is scheduled starting 10:00 is not urgent and may be rescheduled to another day. In other words, the schedule adjuster 131 determines that the holding of the meeting F during the desired meeting time is made possible by rescheduling the meeting time of the meeting 1.

The process (yes path in step S170 and steps S180 through S200) after determining that the holding of the meeting F during the desired meeting time is made possible by adjusting the existing schedule is identical to the corresponding process in the first exemplary embodiment. The discussion of the process is thus not repeated herein.

FIG. 9 illustrates the schedules of the participants that are obtained by adjusting the schedules of the participants in FIG. 7 through the process described above. Specifically, FIG. 9 illustrates the schedules of the users A through E as the participants wherein the schedules of the users B and D within the meeting time serve as an adjustment target in the process described above. Specifically, the meeting time of the meeting 1 is rescheduled to another day or different meeting time and the schedule of the meeting F is incorporated as requested. The rescheduling of the meeting 1 is performed by a participant of the meeting 1 and is not discussed herein.

### Third Exemplary Embodiment

According to each of the first and second exemplary embodiments, even when the referencing of the schedules of the participants determines that the holding of the meeting F as requested is difficult, the analyzing of the conversation log information may determine that the schedules of the participants with respect to the meeting time are adjustable. Specifically, the schedules are arranged by deleting, from the schedule information, schedules that are not to be implemented or shifting, in time, schedules with modifiable meeting time.

According to a third exemplary embodiment, even when the referencing of the schedules of the participants determines that the holding of the meeting F as requested is difficult, the analyzing of the conversation log information may determine that a schedule of the participant with respect to the meeting time is adjustable. If a schedule of a participant having a meeting time length that may be shortened is detected, the holding of the meeting F is made possible in the schedule setting by shortening the meeting time length of the schedule.

The system configuration (FIG. 1) and the meeting setting process (FIG. 2) of the third exemplary embodiment remain unchanged from those of the first exemplary embodiment.

The process of setting the meeting in the third exemplary embodiment is described below.

The third exemplary embodiment is identical to the first exemplary embodiment in the process (steps S110 through S130) that is performed by the user A and includes an operation to select the transmit button 23 on the schedule setting screen 20 to an operation to provide the instruction of the meeting notice. The third exemplary embodiment is identical to the first exemplary embodiment in the process performed when the referencing of the schedule information determines that the holding of the meeting is possible as requested (yes path in step S140). The discussion of these processes is not repeated herein. If the referencing of the schedule information determines that the holding of the meeting during the meeting time is difficult, the schedule adjuster 131 analyzes the schedules of the participants and conversation log information and determines whether the holding of the meeting is possible during the meeting time (no path in step S140 and steps S150 and S160). The third exemplary embodiment is identical to the first exemplary embodiment in this process as well and the discussion of the process is not repeated herein.

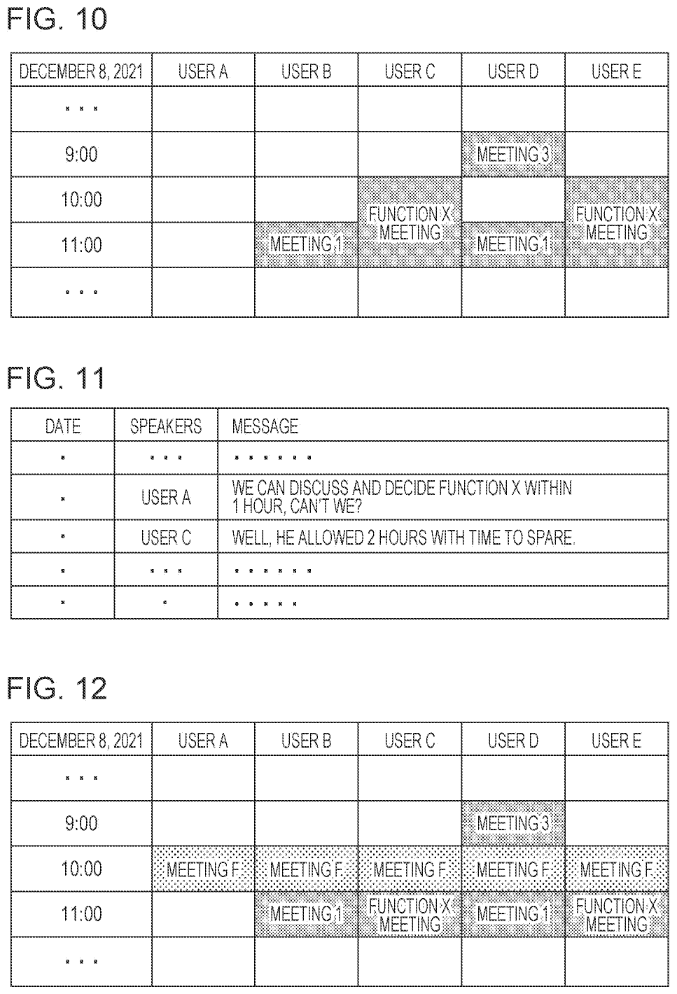

FIG. 10 illustrates a setting example of the schedule information on the participants, obtained in accordance with the third exemplary embodiment, in a time period including the meeting time, and corresponds to FIG. 4 in the first exemplary embodiment. FIG. 11 illustrates part of the log information on a conversation acquired from the chat system 2 in accordance with the third exemplary embodiment and corresponds to FIG. 5 in the first exemplary embodiment.

According to the analyzing of the conversation log information in FIG. 11, users C and E learn that a function X meeting that is scheduled to continue 2 hours starting at 10:00 may be shortened to a time length of 1 hour. Specifically, the schedule adjuster 131 determines that the meeting F may be arranged in the desired meeting time by modifying the planned meeting time of the function X meeting from a 2-hour time frame starting at 10:00 to a 1-hour time frame starting at 11:00.

In this way, upon detecting the schedule of a participant with a meeting time length thereof shortenable, the schedule adjuster 131 shortens the meeting time length of that schedule. The process (yes path in step S170 and steps S180 through S200) after determining that the holding of the meeting F during the desired meeting time is made possible by adjusting the existing schedule is identical to the corresponding process in the first exemplary embodiment. The discussion of the process is thus not repeated herein.

FIG. 12 illustrates the schedules of the participants that are obtained by adjusting the schedules of the participants in FIG. 10 through the process described above. Specifically, FIG. 12 illustrates the schedules of the users A through E as the participants wherein the schedules of the users C and E in the meeting time serve as an adjustment target in the process described above. Specifically, the time length of the function X meeting is rescheduled from 2 hours to 1 hour such that the schedule of the meeting F is incorporated into the desired meeting time.

### Fourth Exemplary Embodiment

According to the first through third exemplary embodiments, even when the referencing of the schedules of the participants determines that the holding of the meeting F as requested is difficult, the holding of the meeting is made possible by adjusting the set schedules of the participants. A fourth exemplary embodiment is based on a determination that the holding of the meeting may be made possible by not adjusting the set schedules of the participants but by modifying the holding condition of the meeting that is to be arranged and is specified in the instruction to produce the meeting notice of the meeting. According to the fourth exemplary embodiment, the schedule of the meeting is arranged by modifying the holding condition of the meeting. The “holding condition” corresponds to the request-to-hold information that is used to arrange the schedule of the meeting on the schedule setting screen 20 when the instruction to produce the meeting notice of the meeting is provided. Specifically, the holding condition is information that is specified on the input region 21 in FIG. 3.

The system configuration (FIG. 1) and the meeting setting process (FIG. 2) of the fourth exemplary embodiment remain unchanged from those of the first exemplary embodiment.

The process of setting the meeting in the fourth exemplary embodiment is described below.

The fourth exemplary embodiment is identical to the first exemplary embodiment in the process (steps S110 through S130) that is performed by the user A and includes an operation to select the transmit button 23 on the schedule setting screen 20 to an operation to provide the instruction of the meeting notice. The fourth exemplary embodiment is identical to the first exemplary embodiment in the process performed when the referencing of the schedule information determines that the holding of the meeting is possible as requested (yes path in step S140). The discussion of these processes is not repeated herein. If the referencing of the schedule information determines that the holding of the meeting during the meeting time is difficult, the schedule adjuster 131 analyzes the schedules of the participants and conversation log information and determines whether the holding of the meeting is possible during the meeting time (no path in step S140 and steps S150 and S160). The fourth exemplary embodiment is identical to the first exemplary embodiment in this process as well and the discussion of the process is not repeated herein.

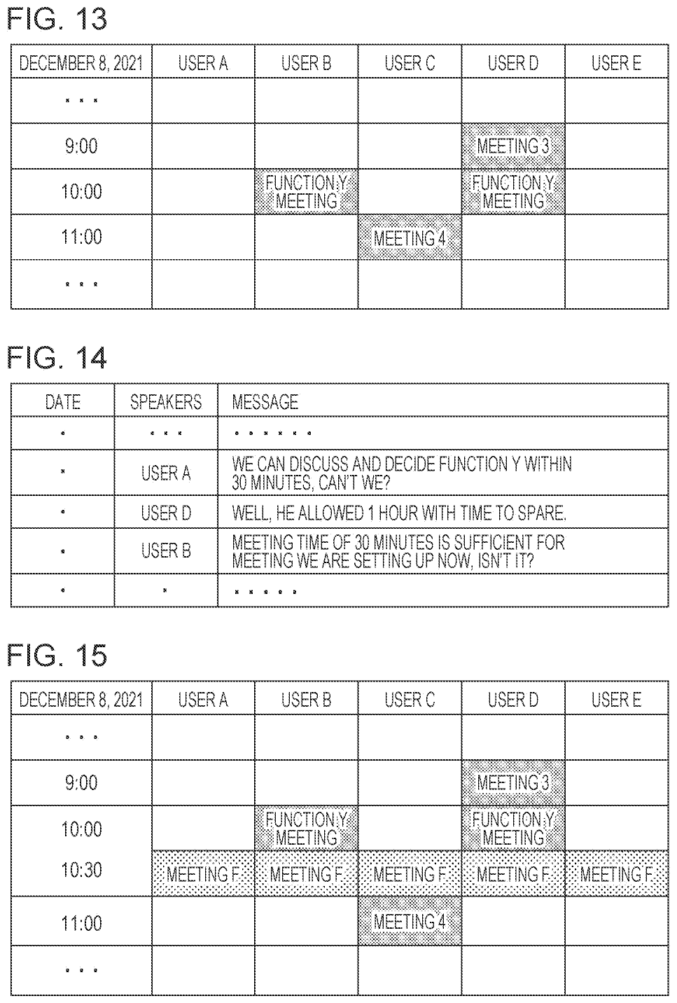

FIG. 13 illustrates a setting example of the schedule information on the participants, obtained in accordance with the fourth exemplary embodiment, in a time period including the meeting time, and corresponds to FIG. 4 in the first exemplary embodiment. FIG. 14 illustrates part of the log information on a conversation acquired from the chat system 2 in accordance with the fourth exemplary embodiment and corresponds to FIG. 5 in the first exemplary embodiment.

The analyzing of the conversation log information in FIG. 14 determines that the holding of the function Y meeting that is scheduled for 1 hour starting at 10:00 for users B and D may be possible within a time length of 30 minutes. The analyzing of the conversation log information in FIG. 14 also determines that the meeting time length of the meeting F is shortenable to 30 minutes.

If the schedule management apparatus 10 determines that the holding of the meeting F is made possible by modifying the holding condition of the meeting F, namely, shortening the meeting time length (yes path in step S170), the schedule management apparatus 10 causes the display controller 122 to display in the result display region 22 the information 24 as to whether the holding of the meeting is possible during the meeting time. The schedule management apparatus 10 thus notifies the user A of the information 24 indicating that the holding of the meeting is possible (step S180). The schedule management apparatus 10 may notify the user A of not only the information 24 indicating that the holding of the meeting is possible but also an indication that the meeting time length is shortened.

If the holding of the meeting F is possible within the shortened time length, the user A selects the enter button 27 after selecting the radio button 26 displayed in response to the information 24. In response to the selection of the enter button 27 by the user A, the schedule manager 13 reflects, in the schedules of the participants, the meeting F to be held within the meeting time identified by the information 24 responsive to the selected radio button 26 (step S190). The schedule manager 13 then notifies the participants that the schedule of the meeting F has been arranged (step S200).

If the user A thinks that the time length of 30 minutes is too short, the user A may select the radio button 29 displayed in response to the information 25 on the alternative meeting time.

FIG. 15 illustrates the schedules of the participants that are obtained by adjusting the schedules of the participants in FIG. 13 through the process described above. Specifically, FIG. 15 illustrates the schedules of the users A through E as the participants wherein the schedules of the users B and D in the meeting time serve as an adjustment target in the process described above. Specifically, the time length of the function Y meeting is rescheduled from 1 hour to 30 minutes such that the schedule of the meeting F is arranged into a time frame of 30 minutes starting from 10:30 and ending at 11:00. The order of the meeting Y meeting and meeting F may be reversed.

### Fifth Exemplary Embodiment

According to the fourth exemplary embodiment, even when the referencing of the schedules of the participants determines that the holding of the meeting F as requested is difficult, the analyzing of the conversation log information may determine that the meeting time length as the holding condition is shortenable. The schedule of the meeting F is arranged by shortening the meeting time length of the meeting F.

According to a fifth exemplary embodiment, the analyzing of the conversation log information determines that the participants may be changed as the holding condition of the meeting F. Changing the participants sets the schedule of the meeting F such that the holding of the meeting F is made possible.

The system configuration (FIG. 1) and the meeting setting process (FIG. 2) of the fifth exemplary embodiment remain unchanged from those of the first exemplary embodiment.

The process of setting the meeting in the fifth exemplary embodiment is described below.

The fifth exemplary embodiment is identical to the first exemplary embodiment in the process (steps S110 through S130) that is performed by the user A and includes an operation to select the transmit button 23 on the schedule setting screen 20 to an operation to provide the instruction of the meeting notice. The fifth exemplary embodiment is identical to the first exemplary embodiment in the process performed when the referencing of the schedule information determines that the holding of the meeting is possible as requested (yes path in step S140). The discussion of these processes is not repeated herein. If the referencing of the schedule information determines that the holding of the meeting during the meeting time is difficult, the schedule adjuster 131 analyzes the schedules of the participants and conversation log information and determines whether the holding of the meeting is possible during the meeting time (no path in step S140 and steps S150 and S160). The fifth exemplary embodiment is identical to the first exemplary embodiment in this process as well and the discussion of the process is not repeated herein.

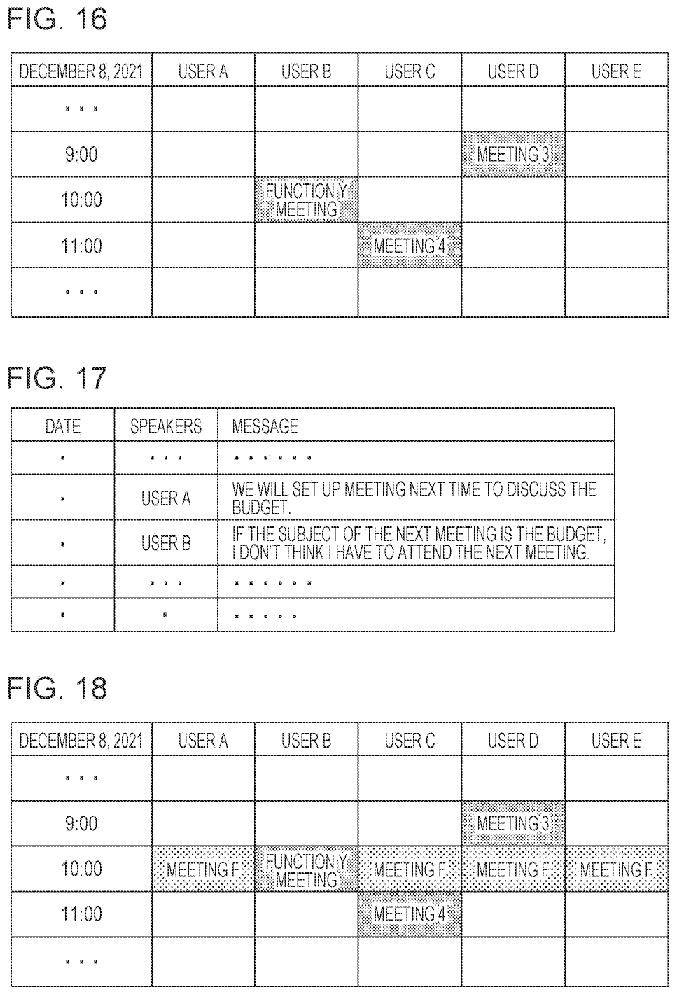

FIG. 16 illustrates a setting example of the schedule information on the participants, obtained in accordance with the fifth exemplary embodiment, in a time period including the meeting time, and corresponds to FIG. 4 in the first exemplary embodiment. FIG. 17 illustrates part of the log information on a conversation acquired from the chat system 2 in accordance with the fifth exemplary embodiment and corresponds to FIG. 5 in the first exemplary embodiment.

The analyzing of the conversation log information in FIG. 17 determines that the user B scheduled for the “function Y meeting” in the meeting time is free from attending the meeting F that is to be arranged.

Specifically, by changing the participants of the meeting F, the schedule adjuster 131 determines that the arrangement of the meeting F within the desired meeting time is possible.

The process (yes path in step S170 and steps S180 through S200) after determining that the holding of the meeting F during the desired meeting time is made possible by adjusting the holding condition of the meeting F serving as a setup target, specifically, by changing the participants to the meeting F, is identical to the corresponding process in the first exemplary embodiment. The discussion of the process is thus not repeated herein.

According to the fifth exemplary embodiment, changing the member of participants to the meeting F signifies that the number of participants to the meeting F is reduced, specifically, the user B is excluded as a member of participants. The disclosure is not limited to this example. For example, participants may be replaced.

The holding condition of the meeting F is changed. In the fourth exemplary embodiment, the meeting time length is changed, and in the fifth exemplary embodiment, a member of participants is changed. The meeting time may also be changed.

According to each of the exemplary embodiments, schedule deletion, schedule shifting, or shortening of the meeting time are is performed depending on the schedules of the participants that are determined by analyzing the conversation log information. These operations may be combined. In such a case, multiple adjustment methods may possibly apply and the adjustment methods may thus be prioritized.

### Sixth Exemplary Embodiment

According to each of the exemplary embodiments, even when the referencing of the schedules of the participants determines that the holding of the meeting F as requested is difficult, the analyzing of the conversation log information may determine that the schedule arranged or the holding condition of the meeting F is modifiable. The schedule is thus arranged through modification such that the meeting F is held.

According to a sixth exemplary embodiment, even when the referencing of the schedules of the participants determines that the holding of the meeting F as requested is difficult, the analyzing of the conversation log information may detect a schedule of a participant having a plan during the meeting time. In such a case, the meeting time of the meeting F may be adjusted.

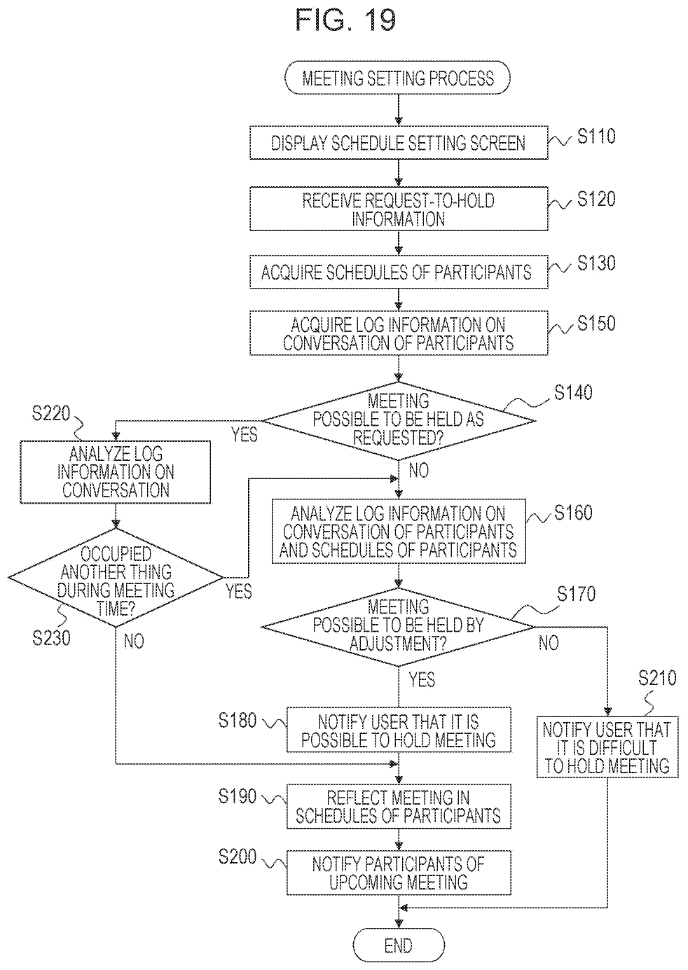

The system configuration (FIG. 1) of the sixth embodiment may be identical to the system configuration of the first exemplary embodiment. The process of setting up a meeting in the sixth exemplary embodiment is described below with reference to a flowchart in FIG. 19. Steps in the sixth exemplary embodiment respectively identical to steps in the first exemplary embodiment are designated with the same step numbers and the discussion thereof is omitted herein.

The sixth exemplary embodiment is identical to the first exemplary embodiment in the process (steps S110 through S130) that is performed by the user A and includes an operation to select the transmit button 23 on the schedule setting screen 20 to an operation to provide the instruction of the meeting notice. According to each of the previous exemplary embodiments described above, if the holding of the meeting F during the meeting time is difficult, the conversation log information is acquired. According to the sixth exemplary embodiment, the conversation log information is acquired before a determination as to whether the holding of the meeting F is possible is made (step S150). The sixth exemplary embodiment is identical to each of the previous exemplary embodiments in the process that is performed after the referencing of the schedule information determines that the holding of the meeting F during the meeting time as requested (no path in step S140). The discussion of the process is omitted herein.

If the referencing of the schedule information determines that the holding of the meeting F as requested is possible (yes path in step S140), the schedule adjuster 131 analyzes the conversation log information (step S220) to determine the possibility that a schedule of a participant is incorporated in the meeting time.

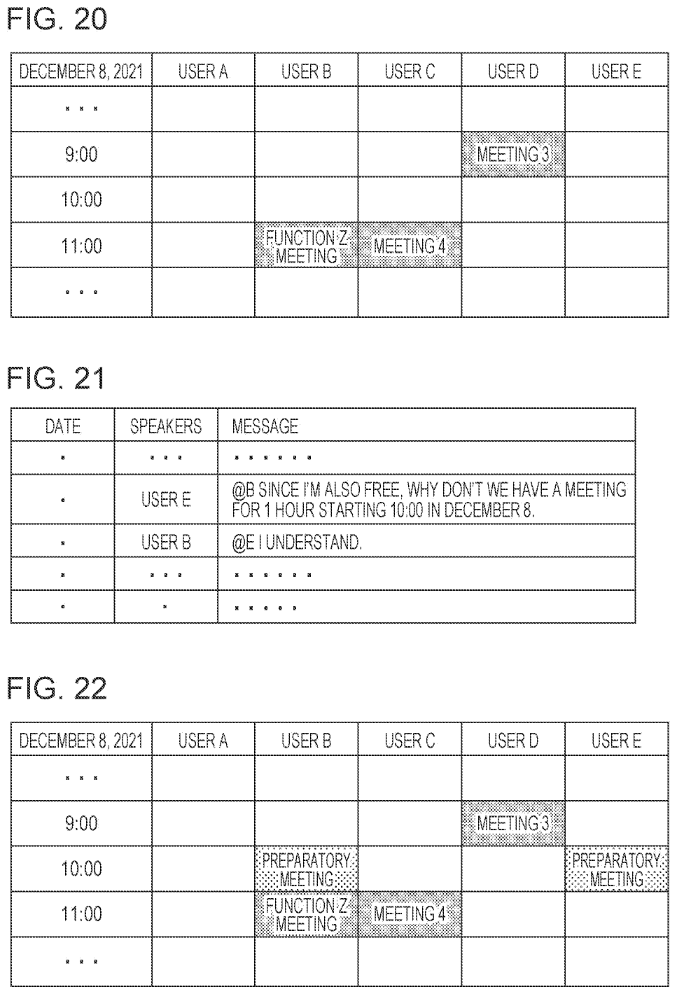

FIG. 20 illustrates a setting example of the schedule information on the participants, obtained in accordance with the sixth exemplary embodiment, in a time period included in the meeting time and corresponds to FIG. 4 in the first exemplary embodiment. FIG. 21 illustrates part of the conversation log information acquired from the chat system 2 in accordance with the sixth exemplary embodiment and corresponds to FIG. 5 in the first exemplary embodiment.

The analyzing of the conversation log information in FIG. 21 determines that users B and E are setting up a preparatory meeting for about 1 hour starting at 10:00 though the preparatory meeting is not yet arranged in the schedule information. FIG. 22 illustrates the schedule information that is not yet scheduled but is expected to be scheduled.

If the analyzing of the conversation log information determines that there is a participant who is going to have another schedule during the meeting time (yes path in step S230), the schedule adjuster 131 determines that the arrangement of the meeting during the desired meeting time is difficult and then proceeds to step S160. If the analyzing of the conversation log information determines that there is no participant who is going to have another schedule during the meeting time (no path in step S230), the schedule adjuster 131 proceeds to step S190.

According to the sixth exemplary embodiment, the referencing of the conversation log information may determine that a plan not yet currently scheduled in the schedule information may be likely to be scheduled. Since the meeting F is set to be not scheduled during that time, cancelling of the meeting involved in schedule overlapping may be controlled.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
receive an instruction to produce a meeting notice;
acquire a schedule of a participant of a meeting, the schedule arranged within a meeting time of the meeting;
if the participant is occupied during the meeting time, acquire log information on a conversation that the participant has made using a messenger application; and
by analyzing the log information on the conversation, display information indicating whether holding of the meeting is possible during the meeting time.

2. The information processing apparatus according to claim 1, wherein the processor is configured to, if the holding of the meeting is possible during the meeting time, display, out of the log information on the conversation, at least contents of the conversation that provide a basis that determines that the holding of the meeting is possible.

3. The information processing apparatus according to claim 1, wherein the processor is configured to display an indication that the holding of the meeting during the meeting time is possible if referencing the schedule of the participant determines that the holding of the meeting during the meeting time is difficult and when the analyzing of the log information determines that the schedule of the participant during the meeting time is adjustable.

4. The information processing apparatus according to claim 3, wherein the processor is configured to arrange the meeting during the meeting time by adjusting the schedule that is determined to be adjustable.

5. The information processing apparatus according to claim 4, wherein the processor is configured to delete the schedule if the analyzing of the log information detects the schedule that does not permit the meeting to be held as arranged during the meeting time.

6. The information processing apparatus according to claim 4, wherein the processor is configured to modify a planned time of the schedule if the analyzing of the log information detects the schedule that permits the planned time during the meeting time to be modified.

7. The information processing apparatus according to claim 4, wherein the processor is configured to shorten a time length of the schedule during the meeting time if the analyzing of the log information detects the schedule that permits the time length of the schedule to be shortened.

8. The information processing apparatus according to claim 3, wherein the processor is configured to, if the analyzing of the log information determines that the holding of the meeting during the meeting time is difficult, display alternative meeting time throughout which the holding of the meeting is possible.

9. The information processing apparatus according to claim 1, wherein the processor is configured to display an indication that the holding of the meeting during the meeting time is possible if referencing the schedule of the participant determines that the holding of the meeting during the meeting time is difficult and when the holding of the meeting is determined to be possible with a modification introduced in a condition to hold the meeting specified in the instruction to produce the meeting notice.

10. The information processing apparatus according to claim 9, wherein the processor is configured to shorten a time length of the meeting time if the analyzing of the log information determines that shortening the time length of the meeting time of the meeting is possible.

11. The information processing apparatus according to claim 9, wherein the processor is configured to change the participant of the meeting if the analyzing of the log information determines that changing the participant is possible.

12. The information processing apparatus according to claim 1, wherein the processor is configured to adjust the meeting time of the meeting if the referencing of the schedule of the participant determines that the holding of the meeting during the meeting time is possible and when the analyzing of the log information detects the schedule of the participant during the meeting time.

13. A non-transitory computer readable medium storing a program causing a computer to execute a process, the process comprising:
receiving an instruction to produce a meeting notice;
acquire a schedule of a participant of a meeting, the schedule arranged within a meeting time of the meeting;
if the participant is occupied during the meeting time, acquiring log information on a conversation that the participant has made using a messenger application; and
by analyzing the log information on the conversation, displaying information indicating whether holding of the meeting is possible during the meeting time.

14. An information processing method comprising:
receiving an instruction to produce a meeting notice;
acquire a schedule of a participant of a meeting, the schedule arranged within a meeting time of the meeting;
if the participant is occupied during the meeting time, acquiring log information on a conversation that the participant has made using a messenger application; and
by analyzing the log information on the conversation, displaying information indicating whether holding of the meeting is possible during the meeting time.
